(19) United States
(12) Patent Application Publication
(10) Pub. No.: US 2013/0238636 A1
(43) Pub. Date: Sep. 12, 2013

(54) SUGGESTING ACCESS-CONTROLLED RELATED QUERIES

(71) Applicants: Shankara B. Subramanya, Sunnyvale, CA (US); Justin Meyer, San Jose, CA (US)

(72) Inventors: Shankara B. Subramanya, Sunnyvale, CA (US); Justin Meyer, San Jose, CA (US)

(73) Assignee: salesforce.com, inc., San Francisco, CA (US)

(21) Appl. No.: 13/603,857

(22) Filed: Sep. 5, 2012

Related U.S. Application Data
(60) Provisional application No. 61/607,076, filed on Mar. 6, 2012.

(51) Int. Cl. G06F 17/30

(52) U.S. Cl. 707/749; 707/767; 707/E17.066

(57) ABSTRACT

In one embodiment, a computer-implemented method executable by a server system to establish suggested queries is provided. The method comprises: receiving an initial query; evaluating a user click log for at least one query that is similar to the initial query based on a document click count of results generated from the at least one query; and generating at least one suggested query based on the at least one query that is similar to the initial query.

### CROSS-REFERENCE TO RELATED APPLICATION

This application claims the benefit of U.S. provisional patent application Ser. No. 61/607,076, filed Mar. 6, 2012, which is hereby incorporated by reference in its entirety.

### TECHNICAL FIELD

Embodiments of the subject matter described herein relate generally to methods and systems for suggesting a query based on an initial query. More particularly, embodiments of the subject matter relate to methods and systems for suggesting queries related to an initial query while controlling access to the data or records to be queried, and access to related queries.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, access can be granted or denied to specific sets of data for any user within the multi-tenant platform, thereby improving collaboration and integration between applications and the data managed by the various applications.

To increase accessibility of the data, multi-tenant architectures allow tenants to be able to query the data. As in any query, in order to find what you are looking for, the appropriate query language must be entered. Accordingly, it is desirable to provide methods and systems for suggesting additional queries to a tenant based on an initial query. In addition, it is desirable to provide methods and systems for suggesting queries that comply with the access controlled data. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system having a query system in accordance with various embodiments;

FIG. 2 is a dataflow diagram illustrating an exemplary query system in accordance with various embodiments; and

FIGS. 3-7 are flowcharts illustrating exemplary query methods in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented here relate to a query system and related techniques, methodologies, procedures, and technology for suggesting queries of access controlled data. The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another.

In accordance with exemplary embodiments described below, a computer based system is provided, such as a multi-tenant system, that is used to provide a query service to a plurality of different tenants, a plurality of different end users, and/or a plurality of different tenant applications. The query system obtains an initial query and performs one or more methods to suggest related queries. The query system manages access of the related queries based on the queries themselves, based on the data to be queried, and/or based on the initiators of the queries.

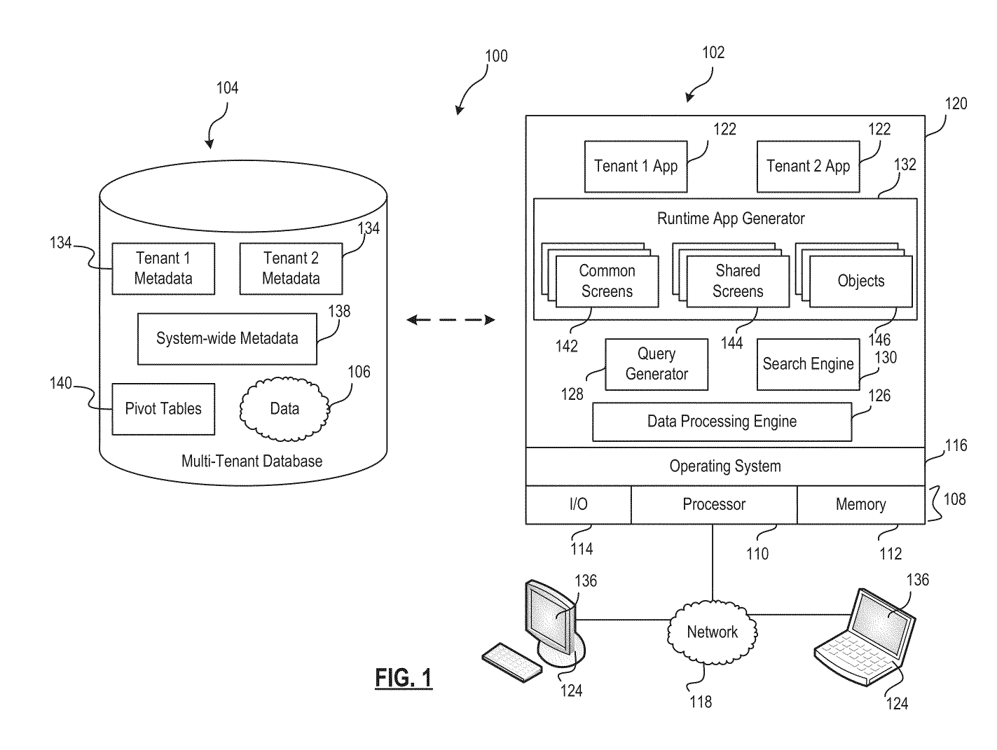

Turning now to FIG. 1, an exemplary multi-tenant application system 100 is shown to include a server 102 that is associated with a multi-tenant database 104. In accordance with various non-limiting examples, the system 100 may be implemented in the form of a multi-tenant customer relationship management system that can support any number of authenticated users of multiple tenants. A “tenant” or an “organization” generally refers to a group of users that shares access to common data 106 within the database 104. Tenants may represent customers, customer departments, business or legal organizations, and/or any other entities that maintain data for particular sets of users within the system 100. Although multiple tenants may share access to the server 102 and the database 104, the particular data and services provided from the server 102 to each tenant can be securely isolated from those provided to other tenants. The multi-tenant architecture therefore allows different sets of users to share functionality while managing the sharing of any or none of the data 106.

The server 102, as shown, generally includes any sort of conventional processing hardware 108, such as a processor 110, memory 112, input/output features 114 and the like, that are managed and accessed by a suitable operating system 116. The processor 110 may be implemented using one or more of microprocessors, microcontrollers, processing cores and/or other computing resources spread across any number of distributed or integrated systems, including any number of “cloud-based” or other virtual systems. The memory 112 represents any non-transitory short or long term storage capable of storing programming instructions for execution on the processor 110, including any sort of random access memory (RAM), read only memory (ROM), flash memory, magnetic or optical mass storage, and/or the like. The input/output features 114 represent conventional interfaces to networks (e.g., to a network 118, or any other local area, wide area or other network), mass storage, display devices, data entry devices and/or the like. As can be appreciated, the server 102 may be implemented using a cluster of actual and/or virtual servers operating in conjunction with each other, typically in association with conventional network communications, cluster management, load balancing and other features as appropriate

The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 112 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The server 102, as shown, further includes an application platform 120 that may be any sort of software application or other data processing engine that generates virtual applications 122 that provide data and/or services to user devices 124. The virtual applications 122 are typically generated at run-time in response to queries received from the user devices 124. The user devices 124 are typically operated by various tenants that subscribe to the system 100.

For the illustrated embodiment, the application platform 120 includes a bulk data processing engine 126, a query generator 128, a search engine 130 that provides text indexing and other search functionality, and a runtime application generator 132. Each of these features may be implemented as a separate process or other module, and many equivalent embodiments could include different and/or additional features, components or other modules as desired.

The data processing engine 126 performs bulk processing operations on the data 106 such as uploads or downloads, updates, online transaction processing, and/or the like that are requested by the query generator 128, the search engine 130, the virtual applications 122, etc. In various embodiments, less urgent bulk processing of the data 106 can be scheduled to occur as processing resources become available, thereby giving priority to more urgent data processing by the query generator 128, the search engine 130, the virtual applications 122, etc.

The runtime application generator 132 dynamically builds and executes the virtual applications 122 in response to specific requests received from the user devices 124. The virtual applications 122 created by or for the tenants are typically constructed in accordance with the tenant-specific metadata 134, which describes particular tables, reports, interfaces and/or other features of the particular application. In various embodiments, each virtual application 122 generates dynamic web content that can be served to a browser or other client program 136 associated with its user device 124, as appropriate. As used herein, such web content represents one type of resource, data, or information that may be protected or secured using various user authentication procedures.

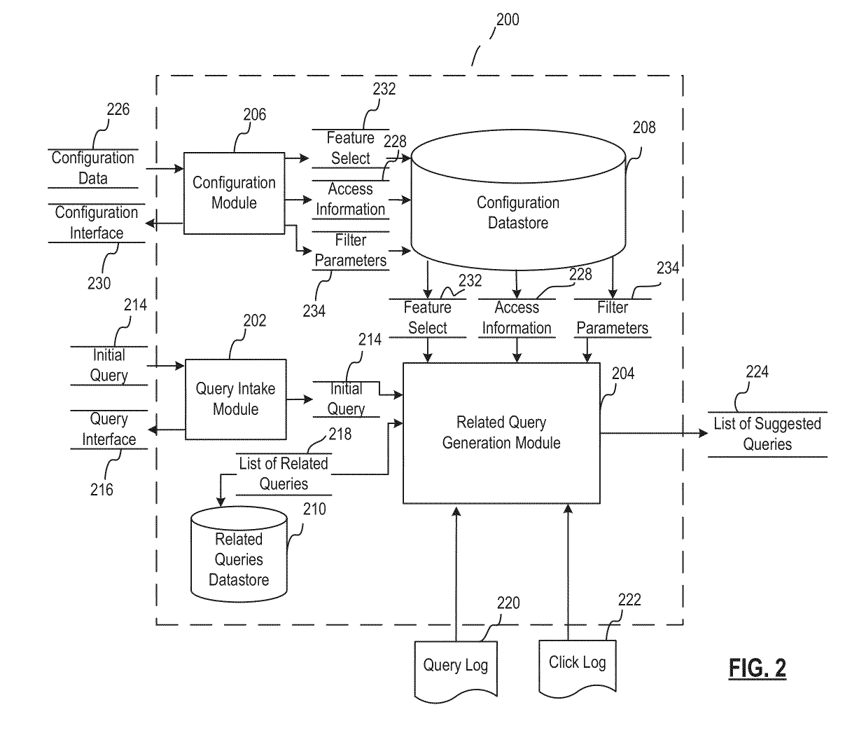

The runtime application generator 132 interacts with the query generator 128 to efficiently obtain multi-tenant data 106 from the database 104 as needed. In various embodiments, the query generator 128 considers the identity of the user requesting a particular function, and then builds and suggests queries to the user. The query generator 128 maintains security of the common database 104 by ensuring that queries are consistent with access privileges granted to a user that initiated the request. The query generator 128 suggests alternate queries based on the initial request while maintaining the security of the common database 104. In various embodiments, the query generator 128 and the processor 110 cooperate in an appropriate manner to perform and manage the various query generation methods described herein in more detail below with reference to FIGS. 2-7.

The database 104 is any sort of repository or other data storage system capable of storing and managing the data 106 associated with any number of tenants. The database 104 may be implemented using any type of conventional database server hardware. In various embodiments, the database 104 shares processing hardware 108 with the server 102. In other embodiments, the database 104 is implemented using separate physical and/or virtual database server hardware that communicates with the server 102 to perform the various functions described herein.

The data 106 may be organized and formatted in any manner to support the application platform 120. In various embodiments, the data 106 is suitably organized into a relatively small number of large data tables to maintain a semi-amorphous “heap”-type format. The data 106 can then be organized as needed for a particular virtual application 122. In various embodiments, conventional data relationships are established using any number of pivot tables 140 that establish indexing, uniqueness, relationships between entities, and/or other aspects of conventional database organization as desired.

Further data manipulation and report formatting is generally performed at run-time using a variety of metadata constructs. The system-wide metadata 138, for example, can be used to describe any number of forms, reports, workflows, user access privileges, business logic and other constructs that are common to multiple tenants. Tenant-specific formatting, functions and other constructs may be maintained as tenant-specific metadata 134 for each tenant, as desired. Rather than forcing the data 106 into an inflexible global structure that is common to all tenants and applications, the database 106 is organized to be relatively amorphous, with the pivot tables 140 and the metadata 134 providing additional structure on an as-needed basis. To that end, the application platform 120 suitably uses the pivot tables 140 and/or the metadata 134 to generate “virtual” components of the virtual applications 122 to logically obtain, process, and present the relatively amorphous data 106 from the database 104.

In operation, developers use the application platform 120 to create data-driven virtual applications 122 for the tenants that they support. Such virtual applications 122 may make use of interface features such as tenant-specific screens 142, universal screens 144 or the like. Any number of tenant-specific and/or universal objects 146 may also be available for integration into tenant-developed virtual applications 122. The data 106 associated with each virtual application 122 is provided to the database 104, as appropriate, and stored until it is requested or is otherwise needed, along with the metadata 134 that describes the particular features (e.g., reports, tables, functions, etc.) of that particular tenant-specific virtual application 122.

The data and services provided by the server 102 can be retrieved using any sort of personal computer, mobile telephone, portable device, tablet computer, or other network-enabled user device 124 that communicates via the network 118. Typically, the user operates a conventional browser or other client program 124 to contact the server 102 via the network 118 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 122, the runtime application generator 132 suitably creates the application at run time based upon the metadata 134, as appropriate. The query generator 128 suitably obtains the requested data 106 from the database 104 as needed to populate the tables, reports or other features of the particular virtual application 122. As noted above, the virtual application 122 may contain Java, ActiveX, or other content that can be presented using conventional client software running on the user device 124; other embodiments may simply provide dynamic web or other content that can be presented and viewed by the user, as desired.

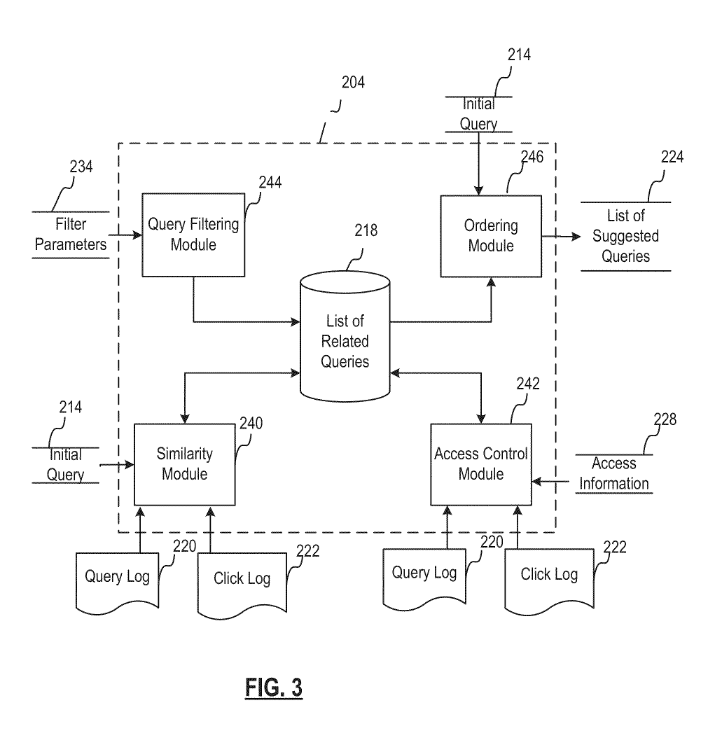

Turning now to FIGS. 2 and 3, block diagrams illustrate an exemplary query generator 200 suitable for use in a computer-implemented server system such as the system 100 shown in FIG. 1 as the query generator 128. This generalized exemplary embodiment of the query generator 200 includes a query intake module 202, a related query generation module 204, a configuration module 206, a configuration datastore 208, and a related queries datastore 210. As can be appreciated, the configuration datastore 208 and the related queries datastore 210 can be any data storage device or a combination of storage devices that may temporarily or permanently store data used by the query generator 200 and may be implemented on the server 102, on the database 104, and/or partly on the server 102 and partly on the database 104.

The query intake module 202 manages the receipt of an initial query 214. As discussed above, the initial query 214 is initiated by a user or tenant (hereinafter referred to as the “initiator”). To obtain the initial query 214, the query intake module 202 manages one or more query interfaces 216 that interface with the initiator. As can be appreciated, the interfaces 216 allow the query to be initiated by a user of through the computing device 124 and/or initiated by a virtual application 122.

The related query generation module 204 generates a list of related queries 218 based on the initial query 214. In various embodiments, the related query generation module 204 periodically generates lists of related queries 218 (e.g., based on common previously initiated queries) and stores them in the related queries datastore 210. The related query generation module 204 then retrieves the stored list based on a similarity between the initial query 214. In various other embodiments the related query generation module 204 generates the list of related queries 218 based on the initiation of the initial query 214 and without retrieving the list from the related queries datastore 210. The related query generation module 204 generates the list of related queries 218

In any of the various embodiments, the related query generation module 204 generates the list of related queries 218 based on an evaluation of a query log 220 and/or a user click log 222. The query log 220 stores, at a minimum, various queries (e.g., queries that have been previously entered) and stores whether the queries were failed queries (e.g., resulting in no selected results by a user) or successful queries (e.g., resulting in selected results). The user click log 222 stores, at a minimum, references to selections of data (user clicks) that are made from the results of the queries.

As will be discussed in more detail with regard to FIG. 3, the related query generation module 204 generates a list of suggested queries 224 by performing one or more filtering and/or ordering methods to obtain the list of related queries 218, or by performing one or more filtering and/or ordering methods on the list of related queries 218. As can be appreciated, the list suggested queries 224 may be used for various purposes. For example, the list of suggested queries 224 may be presented to the initiator of the initial query for further selection and/or may be used to perform the initial query 214 on the data 106.

The configuration module 206 manages various configuration data 226 used by the query generator 200. In various embodiments, the configuration module 206 manages the configuration of access levels and other criteria for determining or filtering the list of related queries 218 and stores the associated data as access information 228 in the configuration datastore 208.

For example, the configuration module 206 manages one or more configuration interfaces 230 that allow a user (e.g., the initiator or an administrator) to configure the access levels for the data, the queries, and/or the initiators. As can be appreciated, the interface(s) may be included as part of one or more interfaces that manage other aspects of the records, the queries, and/or the initiators and/or may be included as a separate interface for configuring query access.

In various embodiments, the configuration module 206 manages the configuration of whether the related queries feature should be turned on or off for any particular query or initiator and stores the information as a feature select data 232 in the configuration datastore 208. For example, the determination of the list of related queries 218 may be turned on or off for particular queries, and/or for particular initiators of queries.

In various embodiments, the configuration module 206 additionally or alternatively manages configuration of filter parameters 234 used in the determination of related queries or the filtering of the related queries. For example, particular terms or phrases to be looked for in queries to determine whether the query should be excluded can be configured and the associated data stored as filter parameters 234 in the configuration datastore 208.

With reference to FIG. 3, the related query generation module 204 is illustrated in accordance with various embodiments. This generalized exemplary embodiment of the relate query generation module 204 includes a similarity module 240, an access control module 242, a query filtering module 244, and an ordering module 246. The modules 240-244 collectively build the list of related queries 218 and the ordering module 246 orders that list of related queries 218 to generate the list of suggested queries 224. As can be appreciated, the order in which the modules perform their functions to build the list of related queries 218 varies in accordance with various embodiments.

The similarity module 240 determines a similarity between the initial query 214 and another query (e.g., queries in the query log 220 or queries already in the list of related queries 218) and adds to or deletes from the list of related queries 218 based on the similarity. For example, the related query generation module 204 can construct a feature vector based on a record click count for each query in the query log 220 and can calculate a similarity score between the initial query 214 and the query (e.g., of the query log 220) using a cosine similarity between the feature vectors or using some other similarity function. The similarity module 240 can determine a list of similar queries based on the similarity scores (e.g., queries having a top X % of the scores). The similarity module 240 may then modify the list of related queries 218 based on the list of the similar queries.

The access control module 242 adds queries to or deletes queries from the list of related queries 218 based on the access information 228. The access information 228 can be associated with the data to be queried, can be associated with the initiators of the queries, and can be associated with the initial queries and the stored queries.

In various embodiments, the access information 228 can indicate a particular access level of the data, an access level of the queries, and/or an access level of the initiators of the queries. For example, the access levels can be, but are not limited to, public access (e.g., least restrictive, any can access), private access (e.g., most restrictive, no one can access), restricted or sensitive access (e.g., restrictive between the least and the most, where a select group can access), or any other type of access.

The access control module 242 uses the access levels of the data to determine whether a particular initiator can have access to queries that produce the particular data. For example, if the data is associated with a record and the record's access level indicates that the record is public, then any query producing that record as a result may be public and available for use in the list of related queries 218 (and not filtered out). In another example, if the record's access level indicates that the record is restricted, then the access level of the initiator of the initial query 214 is evaluated to determine whether the query should be available for use in the list of related queries 218. In yet another example, if the record's access level information indicates that the record is private, then any query producing that record as a result may be private and may not be available for use in the list of related queries 218 (and thus, filtered out).

The access control module 242 uses the access level of the queries to determine whether a particular initiator can have access to particular queries. For example, if a query's access level indicates that the query is public, then the query may be included in the list of related queries 218. In another example, if the query's access level indicates to the query is restricted, then the access level of the initiator of the initial query is evaluated to determine whether the query should be available for use in the list of related queries 218. In yet another example, if the query's access level indicates that the query is private, then the query is excluded from the list of related queries 218 (and thus, filtered out).

The access control module 242 uses the access level of the initiators of the queries to determine whether a particular initiator can have access to queries issued by other initiators. For example, only queries that have the same or a lessor initiator access levels (e.g., lessor being less restrictive) than the access level of the initiator of the initial query 214 can be included in the list of related queries 218 and those queries having greater access levels (e.g., greater being more restrictive) than the access level of the initiator of the initial query 214 can be excluded (or filtered out) from the list of related queries 218.

In another example, a percentage of time a particular query has been issued by an initiator with a particular access level can be evaluated to determine whether the particular query can be included in the list of related queries. For example, if the query was initiated by other initiators having higher permissions than the initiator (thus, y percent of the time the query was issued, it was issued by a user with the same or lesser permissions, where x+y=100%), then only include the query if x is less than or equal to a threshold (e.g., where the threshold is between 0% and 100%).

The query filtering module 244 filters the list related queries 218 based the filter parameters 234 and on one more filtering methods. The filtering methods can be selected and performed on the entire list of related queries 218 or on an individual query. In various embodiments, the filter methods can filter out queries searched only once in the query log; filter out duplicate queries; and/or filter out queries having particular strings (e.g., email addresses, all digits, all punctuation, profanity, etc.). In various embodiments, the filtering methods can filter out queries without any common strings with the initial query 214. However, semantically related queries with no common strings can be preserved by using a transitive closure. In various embodiments, the query filtering module 244 can filter out queries with too much similarity (e.g., filtering out any queries that are lemmas of the initial query); and/or filter out queries with spelling errors.

The ordering module processes the list of related queries 218 to produce an order of the queries. The ordering module 246 then generates the list of suggested queries 224 based on the order.

In various embodiments, the order can be determined using a similarity score. For example, the similarity score can be computed based on a summation of one or more of a string similarity score, a click feature similarity score, and a session similarity score. The string similarity score can be a jacquard similarity on stemmed tokens or engrams. The click feature similarity score can be a score based on a number of common records click and the number of clicks. The session similarity score can be based on a count of times the suggested query occurs in a same suggestion as an original query. The list of suggested queries 224 can then be generated by ordering the related queries with the highest similarity scores first and the lowest similarity scores last.

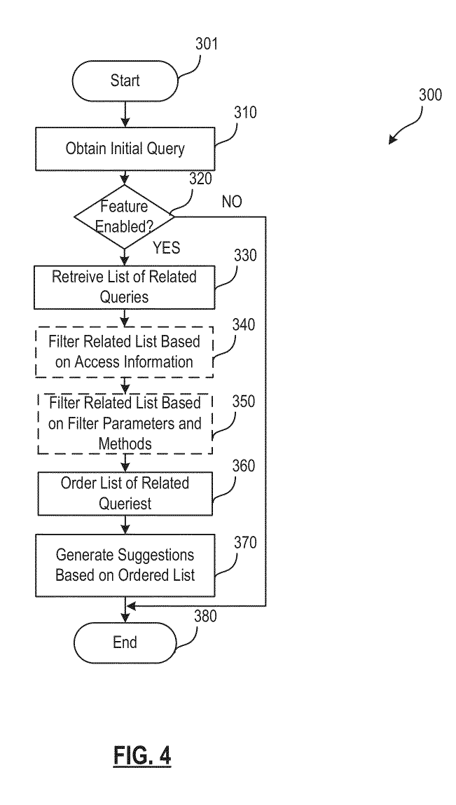

Turning now to FIGS. 4-8, flow charts illustrate exemplary methods 300-500 related to the generation of the suggested queries. The various tasks performed in connection with the methods 300-700 may be performed by software, hardware, firmware, or any combination thereof. In other words, the methods 300-500 may represent a computer-implemented method to establish and manage suggested queries. In particular, the methods 300-700 are executable by a suitably configured server system or a functional module of a server system, such as the query system described above. For illustrative purposes, the following description of the methods 300-700 may refer to elements mentioned above in connection with FIGS. 1-2. In practice, portions of the methods 300-500 may be performed by different elements of the described system, e.g., the query generator 200, the database 104, or the like. As can be appreciated, the methods 300-700 may include any number of additional or alternative steps, the steps shown in FIG. 3 need not be performed in the illustrated order, and the methods 300-500 may be incorporated into a more comprehensive procedure or process having additional functionality not described in detail herein. Moreover, one or more of the steps shown in FIGS. 3-7 could be omitted from embodiments of the methods 300-700 as long as the intended overall functionality remains intact.

The methods 300-700 assumes that the server 102 has already been provided with the modules and functionality described above.

With reference to FIG. 3, a method 300 of generating suggestions is shown. The method 300 assumes that the steps of configuring the feature select data 232, the access information 228, and the parameters 234 have already been performed by the configuration module 206. The method 300 further assumes that lists of related queries 218 for previously entered queries has already been generated and stored in the related queries datastore 210.

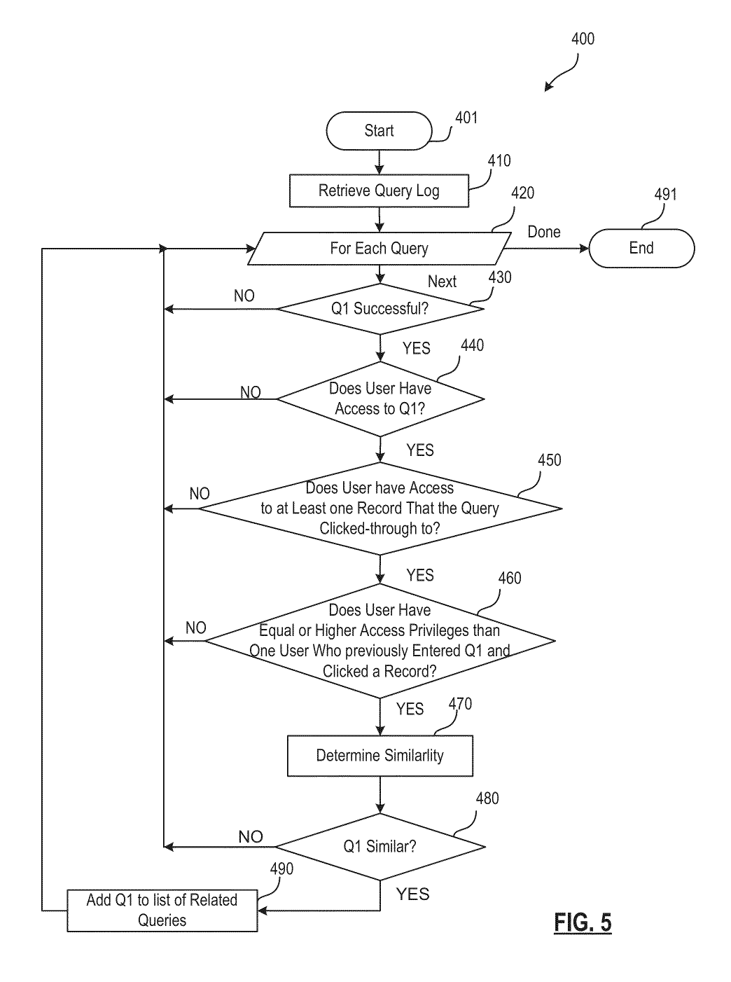

In one example, the method 300 may begin at 301. An initial query is obtained through a query interface at 310. It is then determined whether the related query feature is enabled (e.g., either for the initiator, or the query type) at 320. If the feature is enabled at 320, a list of related queries is retrieved from the datastore based on the initial query at 330. In various embodiments, the list or related queries 218 is generated and stored using one or more of the methods discussed with regard to FIGS. 4 and 5, or other methods.

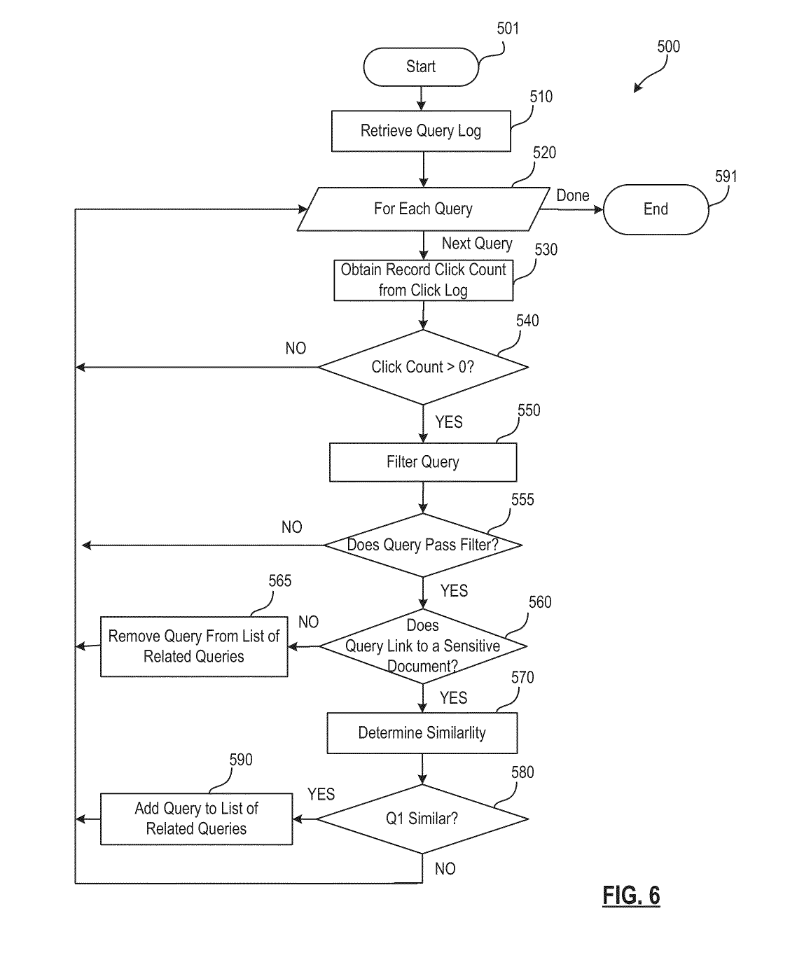

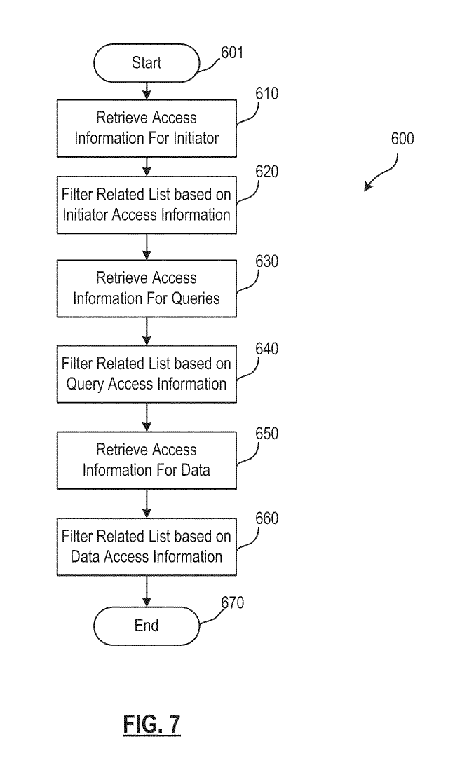

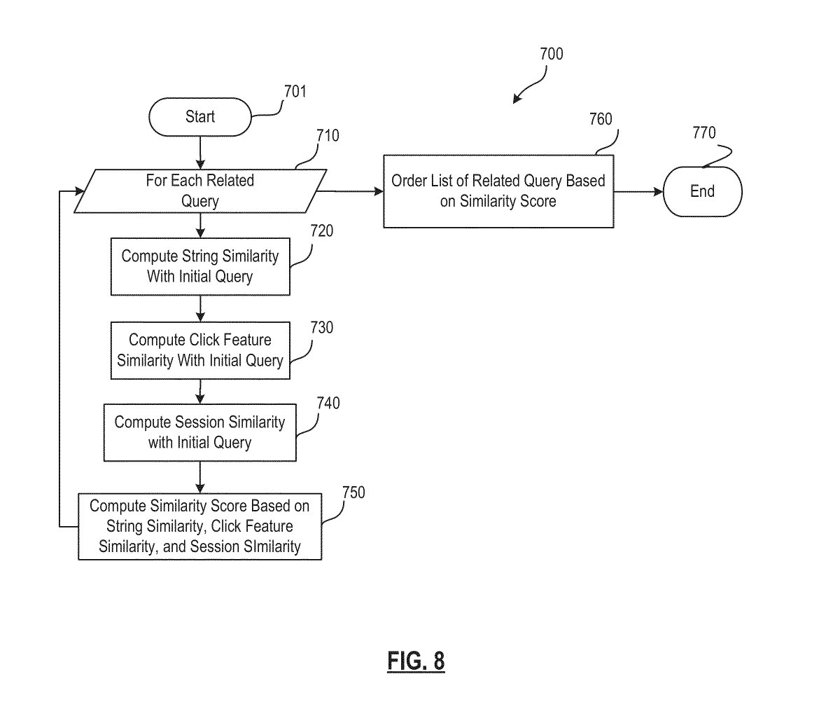

The list of related queries can optionally be filtered based on the access information at 340, for example, as discussed with regard to FIG. 6 (e.g., if the filtering has not already been done during the process of generating the list of related queries). The access-controlled list of related queries can optionally be further filtered based on one or more filter methods and filter parameters at 350, for example, as discussed above (e.g., if the filtering has not already been done during the process of generating the list of related queries). The queries of the filtered query list are then ordered at 360, for example, as discussed with regard to FIG. 7. The list of suggested queries is then generated at 370 based on the ordered list. Thereafter, the method may end at 380.

As can be appreciated, the order of the filtering and the generation of the list of related queries may be varied in various embodiments.

With reference to FIG. 4, a method 400 of generating a list of related queries using the access information 228 is shown. The method 400 assumes that the steps of configuring the access information 228, and the parameters 234 have already been performed by, for example, the configuration module 206.

In one example, the method 400 may begin at 401. The query log 220 is retrieved at 410. Each initial query of the query log is processed at 420-490. For example, for each initial query of the query log at 420, it is determined whether the initial query of the query was successful at 430. If the initial query of the query log was not successful at 430, the method continues with processing the next query at 420. If, however, the initial query of the query log was successful at 430, it is determined whether the access information indicates that the user has access to the query at 440. If the user does not have access to the query at 440, the method continues with processing the next query at 420. If, however, the access information indicates that the user does have access to the query at 440, it is determined whether the user has access to at least one record that the query “clicked-through” to at 450.

If the user does not have access to any record that the query “clicked-through” to at 450, the method continues with processing the next query at 420. If, however, the access information indicates that the user does have access to at least one record that the query “clicked-through” to at 450, it is determined whether the user has access privileges that are equal to or higher than access privileges of at least one user associated with the query and that clicked the record at 460.

If the user does not have access privileges that are equal to or higher than access privileges of at least one user associated with the query and that clicked the record at 460, the method continues with processing the next query at 420. If, however, the access information indicates that the user does have access privileges that are equal to or higher than access privileges of at least one user associated with the query and that clicked the record at 460, the similarity between the query of the query log and the initial query is determined at 470. If the query of the query log is similar to the initial query, query of the query log is added to the list of related queries at 490. If, however, the query of the query log is not similar to the initial query at 480, the query of the query log is not added to the list of related queries and the method continues with processing with the next query at 420. The method continues until the queries of the query log have been processed and the method ends at 491.

With reference to FIG. 5, in one example, a method 500 of generating a list of related queries using the access information 228, and the parameters 234 is shown. The method 500 assumes that the steps of configuring the access information 228, and the parameters 234 have already been performed by, for example, the configuration module 206.

The method 500 may begin at 501. The query log is retrieved at 510. Each query of the query log is processed at 520-590. For example, for each query in the query log at 520, a record click count is obtained from the click log at 530 and is evaluated at 540. If the record click count is not greater than zero at 540, the method continues with processing the next query of the query log at 520. If, however, the click count is greater than zero at 540, the query is filtered using the parameters at 550. If the query does not pass the filters at 555, the method continues with processing the next query of the query log at 520. If however, the query passes the filters at 555 and still remains, it is determined whether the query is associated with a privileged record as indicated by the access information at 560. If the query is associated with a privileged record at 560, the query is removed from the list of related queries at 565 (e.g., if a list has already been generated) and the method continues with processing the next query of the query log at 520. If, however, the query is not associated with a privileged record at 560, the similarity between the query and the initial query is determined at 570. If the query of the query log is similar to the initial query, the query of the query log is added to the list of related queries at 590. If, however, the query of the query log is not similar to the initial query at 580, the query of the query log is not added to the list of related queries and the method continues with processing with the next query at 520. The method continues until the queries of the query log have been processed and the method ends at 591.

With reference to FIG. 6, a method 600 of filtering a list of related queries using the access information 228 after a list or related queries has been generated is shown. The method 500 assumes that the steps of configuring the access information 228 have already been performed by, for example, the configuration module 206.

The method 600 may begin at 601. The access information is retrieved for the initiator at 610. The list of related queries is filtered based on the initiator access information at 620. For example, the list of related queries is evaluated to see if the initiator has been given access to the queries based on the initiator of the queries. If the initiator was not given access, the related query is filtered from the list of related queries.

The access information is retrieved for the queries at 630. The list of related queries is filtered based on the query access information at 640. For example, the list of related queries is evaluated to see if the initiator has been given access to the type of query. If the initiator was not given access, the related query is filtered from the list of related queries.

The access information is retrieved for the data at 650. The list of related queries is filtered based on the data access information at 660. For example, the list of related queries is evaluated to see if the initiator has been given access to particular data and queries that produce the particular data. If the initiator was not given access, the related query is filtered from the list of related queries. Thereafter, the method may end at 670

With reference to FIG. 7, a method 700 of ordering a list or related queries is shown. The method 700 may begin at 701. Each related query of the query list is processed at 710 to 750. For example, for each related query of the list of related queries at 710: a string similarity is computed at 720; a click feature similarity s computed at 730; and a session similarity is computed at 740. As discussed above, the string similarity score can be a jacquard similarity on stemmed tokens or engrams; the click feature similarity score can be a score based on a number of common records click and the number of clicks; and the session similarity score can be based on a count of times the suggested query occurs in a same suggestion as an original query. Thereafter, a similarity score is computed for the related query at 750, for example, as a summation of the string similarity, the feature similarity, and the session similarity.

Once processing of each related query of the list of related queries is complete at 710. The queries are ordered based on their respective similarity score at 760, for example, the related query having the highest similarity score is positioned first in the order and the related queries having lessor similarity scores following thereafter in position. Thereafter, the method may end at 770.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method executable by a multi-tenant server system to establish suggested queries that are access controlled, the method comprising:
receiving an initial query;
generating a list of related queries based on the initial query;
filtering the list of related queries based on access information, wherein the access information is associated with at least one of data to be queried, the related queries, and initiators of the related queries; and
generating the suggested queries based on the list of related queries that has been filtered.

2. The method of claim 1, wherein the access information is associated with data to be queried and wherein the access information is evaluated to determine if an initiator of the initial query has been given access to the data to be queried and a related query that produces the data to be queried.

3. The method of claim 1, wherein the access information is associated with initiators of the related queries and wherein the access information is evaluated to determine if an initiator of the initial query has been given access to the related queries based on an initiator of the related queries.

4. The method of claim 1, wherein the access information is associated with the related queries and the access information is evaluated to determine if an initiator of the initial query has been given access to a type of the related query.

5. The method of claim 1, wherein the access information is associated with the data to be queried, the related queries, and the initiators of the related queries.

6. The method of claim 1, further comprising providing an interface for a tenant of the multi-tenant system to configure the access information and store the access information in a datastore.

7. The method of claim 1, further comprising performing one or more filtering methods on the list of related queries.

8. The method of claim 7, wherein the one or more filtering methods at least one of filter out queries searched X times in the query log; filter out duplicate queries in the plurality of suggested queries; and filter out queries having particular strings.

9. The method of claim 7, wherein the filtering methods filter out queries without any common strings with the initial query.

10. The method of claim 7, wherein the performing the one or more filtering methods is performed on the list of related queries that have been filtered based on the access information.

11. The method of claim 1, further comprising ordering the list of related queries based on a similarity score.

12. The method of claim 11, further comprising determining a similarity score for each of the queries in the list of related queries based on at least one of a string similarity score, a click feature similarity score, and a session similarity score.

13. The method of claim 12, wherein the string similarity score is a jacquard similarity based on at least one of stemmed tokens and engrams.

14. The method of claim 12, wherein the click feature similarity score is based on a number of common records click and a number of clicks.

15. The method of claim 12, wherein the session similarity score is based on a count of times the suggested query occurs in a same suggestion as the original query.

16. The method of claim 1, further comprising generating the list of related queries by determining a similarity between the initial query and another query.

17. The method of claim 16, further comprising determining the similarity between the initial query and the another query based on record click count associated with the another query.

18. A computer program product for establishing suggested queries that are access controlled, comprising:
a tangible storage medium readable by a processing circuit and storing instructions for execution by the processing circuit for performing a method comprising:
receiving an initial query;
generating a list of related queries based on the initial query;
filtering the list of related queries based on access information, wherein the access information is associated with at least one of data to be queried, the related queries, and initiators of the related queries; and
generating the suggested queries based on the list of related queries that has been filtered.

19. A multi-tenant server system for establishing suggested queries that are access controlled, comprising:
a database that stores multi-tenant data; and
a server system that receives an initial query of the multi-tenant data from a tenant, that generates a list of related queries based on the initial query, that filters the list of related queries based on access information, wherein the access information is associated with at least one of data to be queried, the related queries, and initiators of the related queries, and that generates the suggested queries based on the list of related queries that has been filtered.
